(19) United States
(12) Patent Application Publication
(10) Pub. No.: US 2010/0028704 A1
(43) Pub. Date: Feb. 4, 2010

(54) ELASTIC PRE-MOLD FOR OVER-MOLDING AN INSERT

(75) Inventor: Timothy Beaumont AUSTIN, Stony Brook, NY (US)

Correspondence Address: INGRASSIA FISHER & LORENZ, P.C. (Symbol), 7010 E. COCHISE ROAD, SCOTTSDALE, AZ, 85253-1406, US

(73) Assignee: SYMBOL TECHNOLOGIES, INC., Holtsville, NY (US)

(21) Appl. No.: 12/182,010

(22) Filed: Jul. 29, 2008

(51) Int. Cl. B32B 15/08

(52) U.S. Cl. 428/551; 264/279.1

(57) ABSTRACT

An elastic pre-mold (or simply “pre-mold”) is provided on one or more surfaces of a hard insert prior to an over-molding process. The pre-mold layer absorbs or otherwise accommodates shrinkage of the over-mold material, thereby reducing localized mechanical stresses and reducing or eliminating the effects of stress risers. The pre-mold material rounds off corners of the insert that could function as stress risers. The pre-mold material may be one of a variety of thermoplastic and thermoset elastomers.

### TECHNICAL FIELD

The present invention generally relates to plastic molding technology and, more particularly, to methods of reducing mechanical stresses associated with the molding process.

### BACKGROUND

It is often desirable to produce components that include a hard insert molded within a conventional plastic mold material. This process is generally referred to as “over-molding,” and is widely used in the electronics industry in cases were a relatively hard material such (such as a metal or ceramic) is used as a stiffener or other structural member within a generally plastic component.

Conventional over-molding processes are undesirable in a number of respects, however. For example, the plastic molding material typically used for over-molding shrinks by a factor of between about 0.5 and 2.0% as it cools, cures, and hardens. When a hard insert is trapped within the plastic molding material as it shrinks, significant mechanical stresses can result, both on the hard insert and the surrounding molded structure. This can lead to reliability problems, including fractures, fatigue, and subsequent chemical attack.

Accordingly, it is desirable to provide improved over-molding techniques, particular for hard inserts subject to thermo-mechanical stresses during the mold process. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 depicts molding-induced stresses in accordance with conventional processing of an example structure;

FIG. 2 depicts molding-induced stresses in accordance with conventional processing of an example structure;

FIG. 3 depicts a finished over-molded component in accordance with an exemplary embodiment;

FIG. 4 depicts a finished over-molded structure in accordance with an exemplary embodiment; and

FIG. 5 is a flow-chart showing a simplified block diagram of a method in accordance with one embodiment.

### DETAILED DESCRIPTION

The present invention generally relates to a method of reducing mold-induced stresses in over-molded parts using an elastic pre-mold. In this regard, the following detailed description is merely illustrative in nature and is not intended to limit the invention or the application and uses of the invention. Furthermore, there is no intention to be bound by any express or implied theory presented in the preceding technical field, background, brief summary or the following detailed description. For the sake of brevity, conventional techniques related to molding technology, polymers, and mechanical stress/strain characteristics will not be described in detail herein.

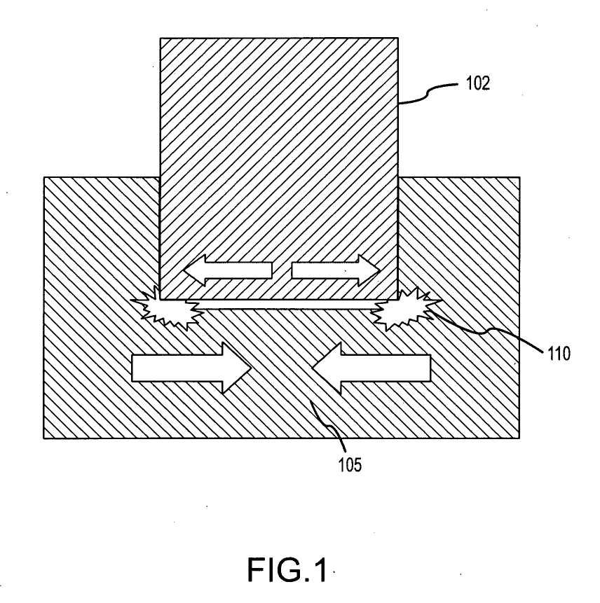

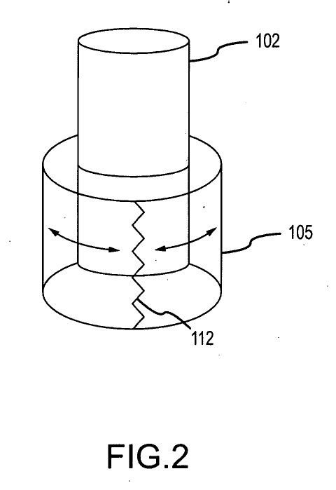

As mentioned previously, conventional over-molding processes are undesirable in that the plastic molding material typically used for over-molding shrinks by a factor of between about 0.5 and 2.0% during processing, particular after the curing and cooling processes. This condition is illustrated in FIGS. 1 and 2. As shown, when a hard insert (or simply “insert”) 102 is trapped (i.e., constrained mechanically) within the plastic molding material (“over-mold”) 105 as it shrinks, mechanical stresses are produced, particularly at sharp internal corners or “stress risers” 110 where compressive and/or tensile stresses are concentrated. As depicted in FIG. 2, in the case of a generally cylindrical hard insert 102, the outer over-mold 105 is subjected to substantial tangential tensile stresses that may exceed the fracture strength of the material, resulting in radial fractures 112.

In accordance with the present invention, an elastic pre-mold (or simply “pre-mold”) is provided on one or more surfaces of the hard insert prior to the over-molding process. The pre-mold layer absorbs or otherwise accommodates shrinkage of the over-mold material, thereby reducing localized mechanical stresses and reducing or eliminating the effects of stress risers. Furthermore, the pre-mold layer may reduce shock loading of the type experienced by the component during sudden impacts.

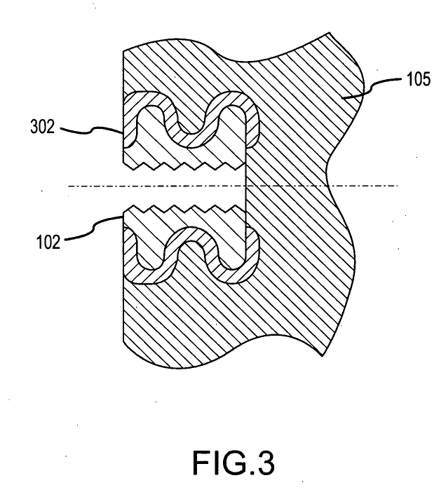

More particularly, FIG. 3 depicts a partial cross-sectional view of an example finished component comprising a hard insert 102 partially encapsulated within an over-mold 105, wherein a portion of the exterior surface of insert 102 is coated by an elastic pre-mold layer 302. It will be appreciated, at the outset, that the example components and structures in the figures are not intended to limit the scope of the present invention, which may be applied to any suitable insert shape or material.

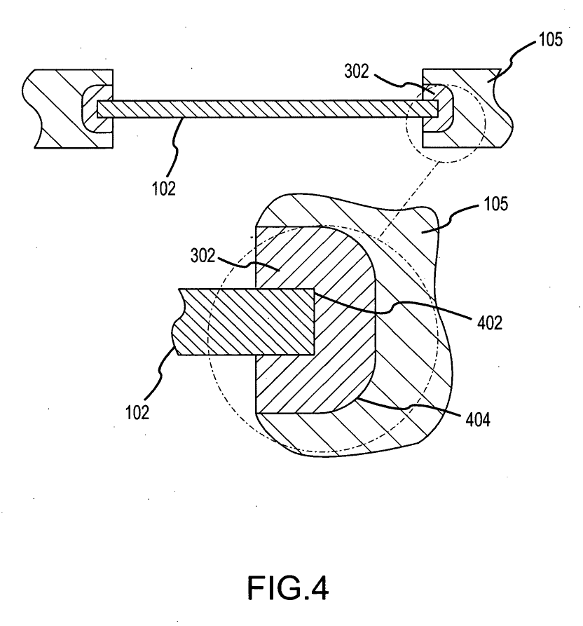

FIG. 4 depicts a partial cross-sectional view of a second example structure. In this example, hard insert 102 is an elongated structure supported between plastic over-mold regions 105. An elastic pre-mold is used to cover the ends of insert 102. As a result, as shown in the inset image, the typically sharp corners 402 of insert 102 do not contact over-mold 105. Rather, over-mold 105 interfaces with the relatively rounded corners 404 of pre-mold 302.

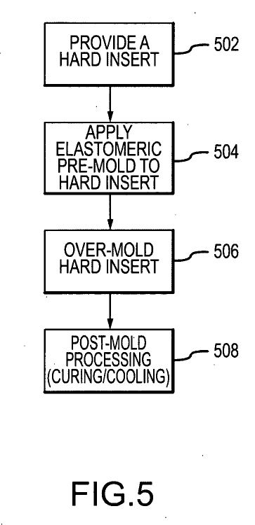

FIGS. 3-4 will now be discussed in conjunction with FIG. 5, which depicts a simplified flow chart of a method in accordance with the present invention. As shown, a hard insert is initially provided (step 502). This insert may have any arbitrary shape and comprise any number of materials, including various metals, ceramics, composite materials, etc. The phrase “hard insert” as used herein is not intended to limit insert 102 to a particular hardness range. Rather, it is intended to suggest, in a non-limiting fashion, that insert 102 will generally have a stiffness, or elastic modulus, that is greater than the surrounding over-mold material 105.

Next, in step 504, elastic pre-mold layer 302 is applied to insert 102. In this regard, elastic pre-mold layer 302 may comprise any suitable elastic material, including, for example, a range of conventional polymeric compounds. In one embodiment, pre-mold layer 302 comprises a thermoset elastomer, such as a silicone rubber material. Such elastomers have the added advantage of maintaining their shape in temperatures experienced during the subsequent over-molding process. Pre-mold layer 302 may be applied using a variety of conventional methods of applying elastic materials such as silicone.

In another embodiment, pre-mold layer 302 comprise a thermoplastic elastomer (for example, thermoplastic polyurethane or polyester elastomer). These materials are particularly advantageous as their increased bonding to the over-molded plastic 105 can improve retention of the insert 102.

When the insert 102 is made from an extruded shape (e.g., a rod or bar), the pre-mold layer may be an extruded outer layer. For mass production of parts with varying cross-section the pre-mold layer may be over-molded using injection molding or compression molding. For smaller production runs, the elastic nature of the pre-mold would allow it to be made as a separate part which could then be stretched over the insert.

The thickness of pre-mold layer 302 may vary or may be constant over the surface of insert 102. The nominal thickness of pre-mold layer 302 may be selected in accordance with a number of factors, including the shape of insert 102, the shape and type of material of over-mold 105, the expected stress and strain experienced by certain regions of over-mold 105 and pre-mold 302, etc. For applications where the pre-mold layer is intended to reduce over-molding stress alone, the thickness of layer 302 is likely to be less than one millimeter, but for applications where the pre-mold layer is also intended to provide some shock isolation, it may be substantially more than one millimeter thick.

In step 506, over-mold structure (or layer) 105 is formed. This may be accomplished in accordance with standard plastic molding techniques. Over-mold 105 may comprise, for example, various thermoset or thermoplastic plastics with or without filler materials. After over-mold 105 is formed, appropriate cooling and/or curing of over-mold layer 105 takes place (step 508).

The finished component incorporating the over-mold layer 105, insert 102, and pre-mold layer 302 may be any type of component, for example, plastic-encapsulated semiconductor devices, computer components, fasteners, glass windows and knob assemblies.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of over-molding comprising:
providing a hard insert;
covering at least a portion of the hard insert with a pre-mold layer;
forming an over-molded structure on at least a portion of the pre-mold layer.

2. The method of claim 1, wherein the hard insert includes at least one corner, and wherein the pre-mold layer coats the at least one corner to form a corner with a greater radius of curvature.

3. The method of claim 1, wherein the hard insert comprises a metal.

4. The method of claim 1, wherein the pre-mold layer is a thermoset elastomer.

5. The method of claim 4, wherein the thermoset elastomer is a silicone material.

6. The method of claim 1, wherein the pre-mold layer is a thermoplastic elastomer.

7. The method of claim 6, wherein the pre-mold layer is a polyurethane or polyester.

8. The method of claim 1, wherein forming the over-molded structure includes forming the over-molded structure over the entire pre-mold layer.

9. The method of claim 1, wherein the pre-mold layer is less than approximately 1.0 mm.

10. An over-molded component comprising:
an insert structure;
a generally elastomeric pre-mold layer over at least a portion of the insert structure; and
an over-molded structure covering at least a portion of the pre-mold layer.

11. The over-molded component of claim 10, wherein the hard insert includes at least one corner, and wherein the pre-mold layer coats the at least one corner to form a corner with a greater radius of curvature.

12. The over-molded component of claim 10, wherein the hard insert comprises a metal.

13. The over-molded component of claim 10, wherein the pre-mold layer is a thermoset elastomer.

14. The over-molded component of claim 13, wherein the thermoset elastomer is a silicone material.

15. The over-molded component of claim 10, wherein the pre-mold layer is a thermoplastic elastomer.

16. The over-molded component of claim 15, wherein the pre-mold layer is a polyurethane or polyester.

17. The over-molded component of claim 10, wherein the over-molded structure is formed over the entire pre-mold layer.

18. The over-molded component of claim 10, wherein the pre-mold layer is less than approximately 1.0 mm.
